(19) United States
(12) Patent Application Publication
(10) Pub. No.: US 2007/0100531 A1
(43) Pub. Date: May 3, 2007

(54) Initiator having wheel sensor function for vehicle and method of controlling the same

(76) Inventor: Cheol-Ho Kim, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,377

(22) Filed: Dec. 8, 2005

(30) Foreign Application Priority Data
Nov. 1, 2005 (KR) 10-2005-0103765

(51) Int. Cl. B60T 7/12

(52) U.S. Cl. 701/71

(57) ABSTRACT

Disclosed herein is an initiator having a wheel sensor function for a vehicle. The initiator includes at least one wheel sensor unit for receiving power from an Antilock Brake System (ABS) unit of a vehicle and outputting a detected vehicle speed to the ABS unit; and at least one initiator unit comprising a controller for receiving power supplied from the ABS unit to the wheel sensor unit, operating using the power and having a ground connected to a TPMS (Tire Pressure Monitoring System) receiver, a reset circuit for switching power applied to the controller, and a coil drive circuit for operating to drive a tire pressure sensor in response to the control signal of the controller to which the power is applied due to the operation of the reset circuit.

### CROSS-REFERENCE TO RELATED APPLICATIONS

The present application is based on, and claims priority from, Korean Application Serial Number 10-2005-0103765, filed on Nov. 1, 2005, the disclosure of which is hereby incorporated by reference herein in its entirety.

### FIELD OF THE INVENTION

The present invention relates generally to an initiator having a wheel sensor function for a vehicle, and a method of controlling the same and, more particularly, to an initiator having a wheel sensor function for a vehicle, in which an initiator for driving the sensor of a tire pressure detection apparatus is integrated with a wheel sensor for sensing a vehicle speed, and a method of controlling the same. For reference, the initiator is also called a Low Frequency Initiator (LFI), and is an apparatus for transmitting a signal using a low frequency of 125 KHz, that is, a low frequency and magnetic field transmission apparatus.

### BACKGROUND OF THE INVENTION

In the tire pressure detection apparatus of a conventional vehicle, a separate initiator is installed to drive a tire pressure sensor mounted in the tire, and then the tire pressure sensor is remotely driven using a wakeup signal, that is, a magnetic field pulse signal of 125 KHz, output from the initiator. Therefore, when the remotely driven tire pressure sensor detects its own unique ID, and the pressure value and temperature of a corresponding tire and then transmits a measured value signal using a wireless frequency of 315 MHz, a receiver receives the transmitted signal and performs an alarm operation or the like depending on the current state of the tire.

Meanwhile, the wheel sensor of a conventional vehicle is a sensor for detecting a vehicle speed required to drive an Antilock Brake System (ABS) unit, using a Hall effect. As known to those skilled in the art, the wheel sensor is mounted adjacent to a tone wheel installed in a wheel and operates in such a way as to convert the difference between magnetic fluxes generated by the rotation of the tone wheel into current so that the ABS unit can read the difference, and output it.

However, the conventional vehicle must have the wheel sensor and the initiator for measuring the tire pressure, which causes increase in manufacturing cost.

### SUMMARY OF THE INVENTION

Embodiments of the present invention provide an initiator having a wheel sensor function for a vehicle, in which the wheel sensor and initiator of the vehicle are integrated into one package, thus having a function of sensing a vehicle speed and an initiator function of driving the sensor of a tire pressure detection apparatus, and a method of controlling the same.

An initiator having a wheel sensor function for a vehicle according to an embodiment of the present invention, including at least one wheel sensor unit for receiving power from an ABS unit of a vehicle and outputting a detected vehicle speed to the ABS unit; and at least one initiator unit comprising a controller for receiving power supplied from the ABS unit to the wheel sensor unit, operating using the power and having a ground connected to a TPMS (Tire Pressure Monitoring System) receiver, a reset circuit for switching power applied to the controller, and a coil drive circuit for operating to drive a tire pressure sensor in response to the control signal of the controller to which the power is applied due to the operation of the reset circuit.

A method of controlling an initiator having a wheel sensor function for a vehicle according to another embodiment of the present invention, comprising the steps of performing a ground connection for driving a corresponding initiator unit after start of a vehicle; operating a controller by driving a reset circuit; outputting a remote drive signal for waking up a tire pressure sensor by driving a coil drive circuit in response to a control signal of the controller; determining whether a remote drive signal frame for the tire pressure sensor has been output; determining whether RF data transmitted from the tire pressure sensor has been received by a TPMS receiver if the signal output has been completed; and cutting off the ground connection of the corresponding initiator unit if the RF data has been received from the tire pressure sensor.

### BRIEF DESCRIPTION OF THE DRAWINGS

For a better understanding of the nature and objects of the present invention, reference should be made to the following detailed description with the accompanying drawings, in which:

FIG. 1 is a diagram showing the construction of an initiator system according to the present invention;

FIG. 2 is a perspective view showing the appearance of an initiator having a wheel sensor function according to the present invention;

FIG. 3a to 3d are diagrams showing the waveforms of the output signals of the wheel sensor unit and the initiator unit of the initiator according to the present invention; and

FIG. 4 is a flowchart of the operation of the initiator according to the present invention.

### DETAILED DESCRIPTION OF THE PREFERRED EMBODIMENTS

A preferred embodiment of the present invention is described with reference to the accompanying drawings.

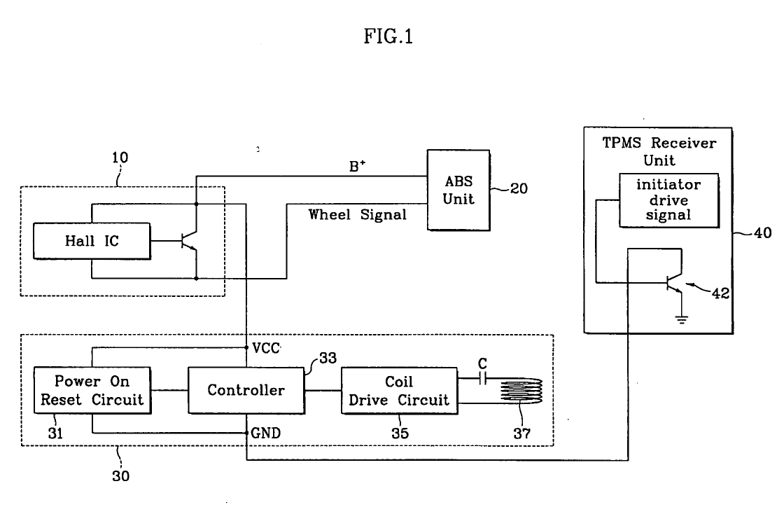

The construction of an initiator having a wheel sensor function for a vehicle according to the embodiment of the present invention is described with reference to FIG. 1.

As illustrated in FIG. 1, the initiator having a wheel sensor function for a vehicle according to the embodiment of the present invention includes a wheel sensor unit 10 for receiving power B+ from the ABS unit 20 of a vehicle and outputting a detected vehicle speed (wheel signal) to the ABS unit 20, and an initiator unit 30 including a controller (microcomputer) 33 configured to receive power (VCC) applied from the ABS unit 20 to the wheel sensor unit 10, operate using the power and have a ground connected to a TPMS receiver 40, a reset circuit 31 for switching power supplied to the controller 33, and a coil drive circuit 35 configured to operate to drive a tire pressure sensor in response to the control signal of the controller 33 to which the power is applied due to the operation of the reset circuit.

In the above-described construction, a coil terminal 37 is connected to the coil drive circuit 35 of the initiator unit 30 according to the present embodiment.

Furthermore, the TPMS receiver 40 further includes a switching device (transistor) 42, which has a collector terminal which is connected to the ground terminal GND of the controller 33, a base terminal to which a signal for driving the initiator unit is applied, and an emitter terminal which is grounded.

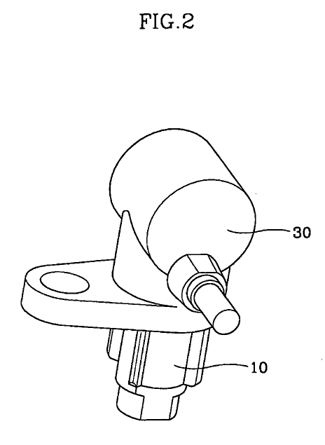

The appearance of the initiator having the wheel sensor function according to the present invention, which has the above-described construction, is shown in FIG. 2.

From FIG. 2, it can be known that the wheel sensor unit 10 for detecting a vehicle speed and the initiator unit 30 of a tire pressure detection apparatus are integrated with each other.

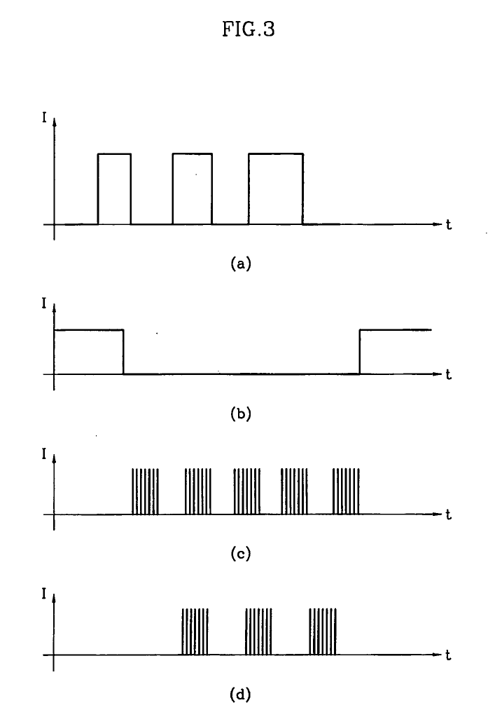

The waveforms of the output signals of the wheel sensor unit 10 and the initiator unit 30 are shown in FIG. 3a to 3d. FIG. 3a is a diagram showing the waveform of the output signal of the wheel sensor unit, FIG. 3b is a diagram showing the waveform of the output signal of the initiator unit when the initiator unit is connected to the ground GND, FIG. 3c is a diagram showing the waveform of the output signal output from the initiator unit in order to wake up the sensor of the tire pressure detection apparatus, and FIG. 3d is a diagram showing the waveform of the RF signal output from the sensor after the sensor has been driven by the wakeup signal transmitted from the initiator unit.

As illustrated in FIG. 3b to 3d, in the state of FIG. 3b, that is, the state in which the initiator unit is connected to the ground, that is, power is applied to the initiator unit in response to the application of an initiator unit drive signal from the TPMS receiver, the output of FIG. 3c results. At this time, the sensor is woken up, so that the RF signal of FIG. 3d is output.

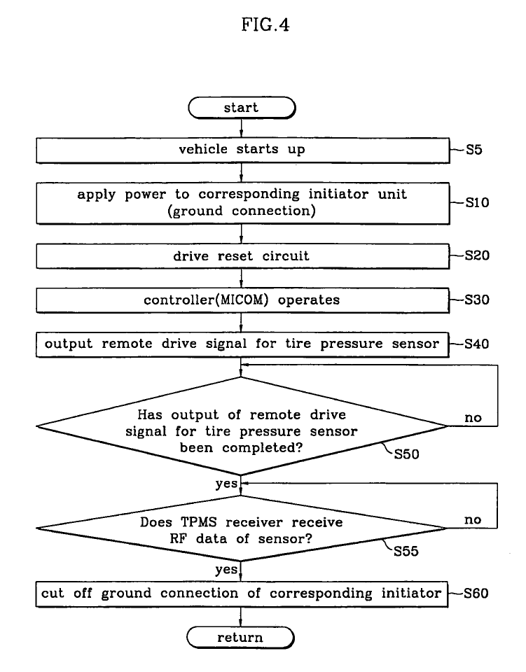

The operation of the initiator having a wheel sensor function according to the present invention, which has the above-described construction, is illustrated in FIG. 4 with reference to FIG. 1.

The initiator according to the present invention is an apparatus which has both vehicle speed detection and initiator functions, thus functioning as the wheel sensor and initiator of a vehicle. In the method of controlling the initiator, the vehicle starts up at step S5, and then ground connection for driving a corresponding initiator unit is performed, that is, power for driving the corresponding initiator unit is applied to the corresponding initiator unit, at step S10. In the above method, the operation of initiator units is performed in the sequence of a front-left initiator unit, a front-right initiator unit, a rear-left initiator unit, and a rear-right initiator unit.

When the ground connection of the corresponding initiator unit is accomplished and then the power is applied at step S10, the controller operates due to the driving of the reset circuit, and then a remote drive signal for waking up the tire pressure sensor is output by driving the coil drive circuit in response to the control signal of the controller at steps S20 to S40.

If, at step S50, it is determined that the output of the remote drive signal from a corresponding initiator is completed at step S40, the TPMS receiver determines whether RF data on the air pressure and temperature of a corresponding tire, which is transmitted from the tire pressure sensor, has been received at step S55.

When the reception of the RF data is normally accomplished at step S55, the TPMS receiver does not apply the initiator drive signal, so that the ground connection of the corresponding initiator is released (off), and, thus, the driving of the corresponding initiator is cut off at step S60.

As described above, the driving of the initiator units is controlled in the sequence of a front-left initiator unit, a front-right initiator unit, a rear-left initiator unit, and a rear-right initiator unit.

In accordance with the initiator having a wheel sensor function for a vehicle and the method of controlling the same, the initiator of the tire pressure detection apparatus of a vehicle and a wheel sensor for detecting a vehicle speed are integrated into a single apparatus, so that there are advantages in that the apparatus thereof is simplified and lightened, and the cost thereof is decreased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An initiator having a wheel sensor function for a vehicle, comprising:
at least one wheel sensor unit for receiving power from an Antilock Brake System (ABS) unit of a vehicle and outputting a detected vehicle speed to the ABS unit; and
at least one initiator unit comprising a controller for receiving power supplied from the ABS unit to the wheel sensor unit, operating using the power and having a ground connected to a TPMS (Tire Pressure Monitoring System) receiver, a reset circuit for switching power applied to the controller, and a coil drive circuit for operating to drive a tire pressure sensor in response to a control signal of the controller to which the power is applied due to operation of the reset circuit.

2. The initiator as defined in claim 1, further comprising:
a switching device having a collector terminal which is connected to the ground of the controller, a base terminal to which a signal for driving the initiator unit is applied, and an emitter terminal which is grounded.

3. The initiator as defined in claim 1, wherein the coil drive circuit of the initiator unit is connected to a coil terminal.

4. A method of controlling an initiator having a wheel sensor function for a vehicle, comprising the steps of:
performing a ground connection for driving a corresponding initiator unit after start of a vehicle;
operating a controller by driving a reset circuit;
outputting a remote drive signal for waking up a tire pressure sensor by driving a coil drive circuit in response to a control signal of the controller;
determining whether a remote drive signal frame for the tire pressure sensor has been output;
determining whether RF data transmitted from the tire pressure sensor has been received by a TPMS receiver if the signal output has been completed; and
cutting off the ground connection of the corresponding initiator unit if the RF data has been received from the tire pressure sensor.

5. The method as defined in claim 4, wherein operation of initiator units is performed in a sequence of a front-left initiator unit, a front-right initiator unit, a rear-left initiator unit, and a rear-right initiator unit.
